(19) United States
(12) Patent Application Publication
(10) Pub. No.: US 2026/0107941 A1
(43) Pub. Date: Apr. 23, 2026

(54) USE OF 4-(DIETHYLAMINO)SALICYLALDEHYDE IN CONTROLLING PHYTOPATHOGEN, METHOD FOR CONTROLLING PHYTOPATHOGEN, AND BACTERICIDE

(71) Applicant: SHIHEZI UNIVERSITY, Xinjiang (CN)

(72) Inventors: Guoqiang ZHANG, Xinjiang (CN); Jing ZHAO, Xinjiang (CN); Sishi HUANG, Xinjiang (CN); Lijing YUAN, Xinjiang (CN); Xiaoyue YANG, Xinjiang (CN); Qinghua LI, Xinjiang (CN)

(21) Appl. No.: 18/868,427

(22) PCT Filed: Mar. 8, 2024
(86) PCT No.: PCT/CN2024/080660

§ 371 Date: Nov. 22, 2024

(30) Foreign Application Priority Data
Dec. 11, 2023 (CN) 202311702567.9

(51) Int. Cl. A01N 35/04; A01P 1/00; A01P 3/00

(52) U.S. Cl. CPC A01N 35/04; A01P 1/00; A01P 3/00

(57) ABSTRACT

The present disclosure belongs to the technical field of plant disease control, and specifically relates to use of 4-(diethylamino)salicylaldehyde in controlling a phytopathogen, a method for controlling a phytopathogen, and a bactericide. The 4-(diethylamino)salicylaldehyde shows an excellent inhibitory effect on the phytopathogen (including a phytopathogenic fungus and/or a phytopathogenic bacterium), especially has the best inhibitory effect on Rhizoctonia solani and Erwinia amylovory, and exhibits a potential to be developed into a novel bactericide.

The present application claims priority to the Chinese Patent Application No. CN202311702567.9, filed with the China National Intellectual Property Administration (CNIPA) on Dec. 11, 2023, and entitled “USE OF 4-(DIETHYLAMINO)SALICYLALDEHYDE IN CONTROLLING PHYTOPATHOGEN, METHOD FOR CONTROLLING PHYTOPATHOGEN, AND BACTERICIDE”, which is incorporated herein by reference in its entirety.

### TECHNICAL FIELD

The present disclosure belongs to the technical field of plant disease control, and specifically relates to use of 4-(diethylamino)salicylaldehyde in controlling a phytopathogen, a method for controlling a phytopathogen, and a bactericide.

### BACKGROUND

A plant disease refers to the phenomenon that plants undergo a series of morphological, physiological, and biochemical pathological changes under the influence of biotic or abiotic factors, hindering the normal growth and development, thus affecting human economic benefits. The plant disease has caused huge economic losses to agricultural production. However, currently there is a relative lack of bactericides for controlling plant diseases, and phytopathogens have developed varying degrees of resistance to the bactericides that are still widely used, resulting in a gradual reduction of available chemicals. Therefore, it is of great significance to ensure the safety of agricultural production to find and develop novel bactericides.

### SUMMARY

In view of this, an objective of the present disclosure is to provide use of 4-(diethylamino)salicylaldehyde in controlling a phytopathogen, a method for controlling a phytopathogen, and a bactericide. The 4-(diethylamino)salicylaldehyde shows a desirable inhibitory effect on the phytopathogen.

To achieve the above objective, the present disclosure provides the following technical solutions:

The present disclosure provides use of 4-(diethylamino)salicylaldehyde in controlling a phytopathogen.

Preferably, the phytopathogen includes a phytopathogenic fungus and/or a phytopathogenic bacterium.

Preferably, the phytopathogen is one or more selected from the group consisting of Rhizoctonia solani, Colletotrichum orbiculare, Cladosporium fulvum, Alternaria alternata, Fusarium oxysporum, Xanthomonas oryzae, Pseudomonas syringae pv. lachrymans, Erwinia amylovory, and Acidovorax citrulli.

The present disclosure further provides a method for controlling a phytopathogen, including applying a 4-(diethylamino)salicylaldehyde solution to a phytopathogen-infected plant.

Preferably, 4-(diethylamino)salicylaldehyde in the 4-(diethylamino)salicylaldehyde solution has a concentration of 50 mg/L to 500 mg/L.

Preferably, a preparation process of the 4-(diethylamino)salicylaldehyde solution includes dissolving the 4-(diethylamino)salicylaldehyde in dimethyl sulfoxide (DMSO) and then diluting with water.

Preferably, the plant is a pear tree; and 3 L of the 4-(diethylamino)salicylaldehyde solution is sprayed on each pear tree during the applying.

Preferably, the applying is conducted 1 to 5 times.

Preferably, the applying is conducted at 1 d/time to 7 d/time.

The present disclosure further provides a bactericide, including 4-(diethylamino)salicylaldehyde and a pesticide adjuvant.

The present disclosure provides use of 4-(diethylamino)salicylaldehyde in controlling a phytopathogen. The 4-(diethylamino)salicylaldehyde shows an excellent inhibitory effect on the phytopathogen (including a phytopathogenic fungus and/or a phytopathogenic bacterium), can cause abnormal cell morphology and ultrastructural damage of the phytopathogen, hinder microbial DNA synthesis, and disrupt genetic metabolic function of cells, thereby inhibiting the growth of phytopathogens or killing the phytopathogens. The results of examples show that the 4-(diethylamino)salicylaldehyde has the best inhibitory effect on Rhizoctonia solani, with a median effective concentration (EC₅₀) of 14.487 mg/L, and an EC₅₀ of 40.785 mg/L against Fusarium oxysporum. The 4-(diethylamino)salicylaldehyde not only has an inhibitory effect on the phytopathogenic fungus, but also has a desirable inhibitory effect on the phytopathogenic bacterium. The EC₅₀ against Erwinia amylovory and Acidovorax citrulli are 92.083 mg/L and 108.494 mg/L, respectively.

### DETAILED DESCRIPTION OF THE EMBODIMENTS

The present disclosure provides use of 4-(diethylamino)salicylaldehyde in controlling a phytopathogen.

Unless otherwise specified, the present disclosure has no special requirements for sources of the used raw materials, and commercially-available products well known to those skilled in the art may be adopted.

In the present disclosure, the 4-(diethylamino)salicylaldehyde has a CAS number of 17754-90-4, a chemical formula of C₁₁H₁₅NO₂, a molecular weight of 193.24, and a structural formula as follows:

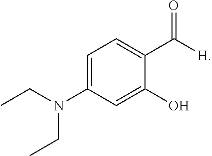

In the present disclosure, the phytopathogen includes preferably a phytopathogenic fungus and/or a phytopathogenic bacterium, more preferably the phytopathogenic fungus; the phytopathogenic fungus is one or more selected from the group consisting of Rhizoctonia solani, Colletotrichum orbiculare, Cladosporium fulvum, Alternaria alternata, Fusarium oxysporum, and Xanthomonas oryzae; and the phytopathogenic bacterium is one or more selected from the group consisting of Pseudomonas syringae pv. lachrymans, Erwinia amylovory, and Acidovorax citrulli.

In the present disclosure, the phytopathogen is preferably one or more selected from the group consisting of Rhizoctonia solani, Colletotrichum orbiculare, Cladosporium fulvum, Alternaria alternata, Fusarium oxysporum, Xanthomonas oryzae, Pseudomonas syringae pv. lachrymans, Erwinia amylovory, and Acidovorax citrulli, more preferably the Rhizoctonia solani, Colletotrichum orbiculare, Cladosporium fulvum, Alternaria alternata, Fusarium oxysporum, Xanthomonas oryzae, Pseudomonas syringae pv. lachrymans, Erwinia amylovory, or Acidovorax citrulli.

In the present disclosure, there are no special restrictions on the use of the 4-(diethylamino)salicylaldehyde in controlling the phytopathogen, and use methods well known in the art can be used.

The present disclosure further provides a method for controlling a phytopathogen, including applying a 4-(diethylamino)salicylaldehyde solution to a phytopathogen-infected plant.

In the present disclosure, 4-(diethylamino)salicylaldehyde in the 4-(diethylamino)salicylaldehyde solution has a concentration of preferably 50 mg/L to 500 mg/L, more preferably 100 mg/L to 400 mg/L; a preparation process of the 4-(diethylamino)salicylaldehyde solution includes preferably dissolving the 4-(diethylamino)salicylaldehyde in DMSO and then diluting with water.

In the present disclosure, there is no special limitation on a method of the applying, which can be selected according to actual conditions. In examples, the applying is conducted by root irrigation or stem and leaf spraying.

In the present disclosure, the applying is conducted preferably 1 to 5 times, more preferably 2 to 3 times; and the applying is conducted at preferably 1 d/time to 7 d/time, more preferably 3 d/time to 7 d/time. There is no special limitation on a dosage of the 4-(diethylamino)salicylaldehyde solution for each applying, and the dosage can be selected according to the actual situation. In examples, 50 mL of the 4-(diethylamino)salicylaldehyde solution with a concentration of (50-150) mg/L is applied each time in the pot test, and 3 L of the 4-(diethylamino)salicylaldehyde solution with a concentration of (200-400) mg/L is applied each time in the field test.

In the present disclosure, there are no special limitations on plant species and application sites, and the solution can be applied to parts of plants infected with the phytopathogen according to actual needs.

The present disclosure further provides a bactericide, including 4-(diethylamino)salicylaldehyde and a pesticide adjuvant.

In the present disclosure, there are no special limitations on a dosage and a type of the pesticide adjuvant in the bactericide, which can be selected according to needs.

The technical solutions in the present disclosure will be described below clearly and completely with reference to the examples in the present disclosure, but they shall not be construed as limiting the scope of protection of the present disclosure.

### Example 1

A toxicity of the 4-(diethylamino)salicylaldehyde on Rhizoctonia solani, Colletotrichum orbiculare, Cladosporium fulvum, Alternaria alternata, and Fusarium oxysporum were detected using the NY/f 1156.2-2006, mycelial growth rate method.

A PDA solid medium was heated, melted, shaken, and cooled to about 45° C.; a medicinal solution (filtered with a 0.22 μm sterile filter) and the PDA solid medium were mixed, cooled to obtain a drug-containing medium plate with a certain concentration; a phytopathogen cake was placed in the center of the plate, and cultured at 28° C. for 3 d to 7 d; when the hyphae of the phytopathogen in the control group were about to fill the dish, a colony diameter was measured using a cross method, and the mycelial growth inhibition rate and toxicity were calculated. The results were shown in Table 1.

$$Mycelial growth inhibition rate ( \% ) = ( diameter of colony in control group - diameter of colony in treatment group ) / diameter of colony in control group \times 100$$

TABLE 1
Toxicity of 4-(diethylamino)salicylaldehyde to 5 phytopathogenic fungi

| Pathogen | Toxicity curve | R² | EC₅₀ | 95% confidence interval |
|---|---|---|---|---|
| R. solani | y = 3.560x − 4.133 | 0.967 | 14.487 | 12.014-20.694 |
| C. orbiculare | y = 1.102x − 2.173 | 0.999 | 93.754 | 68.567-151.478 |
| C. fulvum | y = 1.309x − 2.686 | 0.979 | 112.612 | 79.571-191.767 |
| A. alternata | y = 1.159x − 2.668 | 0.999 | 200.335 | 115.496-528.222 |
| F. oxysporum | y = 1.235x − 2.228 | 0.999 | 40.785 | 49.019-99.523 |

As shown in Table 1, through antibacterial activity measurement, it was found that the 4-(diethylamino)salicylaldehyde (DSA) had varying degrees of inhibitory effects on the 5 phytopathogenic fungi, where the DSA showed the strongest inhibitory effect on Rhizoctonia solani, with an EC₅₀ of 14.487 mg/L; while the effect on Fusarium oxysporum took second place, with an EC₅₀ of 40.785 mg/L.

### Example 2

The toxicity of the 4-(diethylamino)salicylaldehyde to Xanthomonas oryzae, Pseudomonas syringae pv. lachrymans, Erwinia amylovory, and Acidovorax citrulli was detected using the NYT 1156.16-2008, turbidity method.

An activated strain growing on the NA medium plate was diluted with sterile water to obtain a suspension with a concentration of 1×10⁷ CFU/mL, 100 μL of the suspension was added to a sterilized and cooled NB medium, and then a certain amount of medicinal solution was added, and subjected to shaking culture at 30° C. for 2 d to 3 d. The turbidity of each treatment was measured before cultivation. When the control group reached the logarithmic growth phase, the turbidity of each treatment was measured, and the growth inhibition rate and toxicity were calculated. The results were shown in Table 2.

$$Growth inhibition rate ( \% ) = ( increased value of turbidity in control group - increased value of turbidity in treatment group ) / increased value of turbidity in control group \times 100$$

TABLE 2
Toxicity of 4-(diethylamino)salicylaldehyde to 4 phytopathogenic bacteria

| Pathogen | Toxicity curve | R² | EC₅₀ | 95% confidence interval |
|---|---|---|---|---|
| X. oryzae | y = 3.691x − 7.881 | 0.999 | 136.481 | 23.676-422.851 |
| P. syringae pv. lachrymans | y = 4.881x − 10.048 | 0.999 | 114.422 | 35.916-223.502 |
| E. amylovory | y = 1.953x − 3.836 | 0.994 | 92.083 | 83.831-101.509 |
| A. citrulli | y = 1.111x − 2.260 | 0.984 | 108.494 | 84.815-150.120 |

As shown in Table 2, the DSA also had a desirable inhibitory effect on phytopathogenic bacteria, where the EC₅₀ against Erwinia amylovory and Acidovorax citrulli were 92.083 mg/L and 108.494 mg/L, respectively. The results showed that DSA had a broad antibacterial spectrum.

### Example 3

The control effects of 50 mg/L, 100 mg/L and 150 mg/L 4-(diethylamino)salicylaldehyde on Rhizoctonia solani were determined using a pot method.

A Rhizoctonia solani suspension (10⁷ CFU/mL) was added to a matrix at a ratio of 20:1 (w/w), mixed well, germinated cotton seeds were sown into the matrix, and then 50 mL of the medicinal solution was applied on 1 d, 3 d, 5 d, and 7 d separately. After culturing for 10 d, the incidence rate was investigated and the control effect was calculated. The results were shown in Table 3.

TABLE 3
Control effect of 4-(diethylamino)salicylaldehyde on Rhizoctonia solani

| Treatment | Incidence (%) | Control effect (%) |
|---|---|---|
| 50 mg/L 4-(diethylamino)salicylaldehyde | 20.00 | 60.66c |
| 100 mg/L 4-(diethylamino)salicylaldehyde | 11.67 | 77.05b |
| 150 mg/L 4-(diethylamino)salicylaldehyde | 6.67 | 86.89a |
| 100 mg/L carbendazim | 25.83 | 49.18d |
| Blank control | 50.83 | — |

As shown in Table 3, the pot test results proved that the control effects of 4-(diethylamino)salicylaldehyde at concentrations of 50, 100, and 150 mg/L on Rhizoctonia solani were 60.66%, 77.05%, and 86.89%, respectively, which were all better than that of the control group treated with 100 mg/L carbendazim. This indicated that the 4-(diethylamino)salicylaldehyde could significantly reduce the incidence of damping-off at the test dose.

### Example 4

In 2023, the control effect of the 4-(diethylamino)salicylaldehyde on pear fire blight was measured in fragrant pear orchards in the Korla region of Xinjiang. In the area where pear fire blight occurred in Korla, a pear orchard with uniform growth and uniform disease occurrence was selected, with a tree age of 25 to 30 years. There were 2 trees per replicate, with a total of four replicates, and each tree was sprayed with 3 L of the medicinal solution (the concentrations of 4-(diethylamino)salicylaldehyde were 200, 300, and 400 mg/L). The spraying was started at the beginning of the pear tree's flowering period and the drug was applied 3 times at 7 d/time. The test results were investigated 7 d to 14 d after the last application.

Each pear tree was surveyed at 5 locations in the east, west, south, north, and middle. The ratio of the diseased area of 10 current-year branches to the entire branches at each point was investigated, and the number of diseased branches and corresponding disease levels in each treatment were recorded.

The classification criteria for diseased branches were as follows:
Level 0, no occurrence, no lesions on branches;
Level 1, diseased area of the branches accounting for less than 5% of the entire branches;
Level 3, diseased area of the branches accounting for 6% to 15% of the entire branches;
Level 5, diseased area of the branches accounting for 16% to 30% of the entire branches;
Level 7, diseased area of the branches accounting for 31% to 50% of the entire branches;
Level 9, diseased area of the branches accounting for more than 50% of the entire branches.

### Calculation Method of Control Effect:

$$Disease index = [ Σ ( number of diseased leaves \times disease level ) / total number of leaves \times highest disease level ] \times 100$$

$$Control effect ( \% ) = ( control group disease index - treatment group disease index ) / control group disease index \times 100 , the results were shown in Table 4.$$

TABLE 4
Control effect of 4-(diethylamino)salicylaldehyde on pear fire blight

| | Control effect (%) | |
|---|---|---|
| Treatment | 7 d after last dose | 14 d after last dose |
| 200 mg/L 4-(diethylamino)salicylaldehyde | 40.85c | 35.14c |
| 300 mg/L 4-(diethylamino)salicylaldehyde | 50.37b | 44.71b |
| 400 mg/L 4-(diethylamino)salicylaldehyde | 58.13a | 50.81a |
| 50 mg/L zhongshengmycin | 53.06ab | 47.36b |

As shown in Table 4, the field test results proved that the 4-(diethylamino)salicylaldehyde had a desirable control effect on pear fire blight at the test dose. The control effects of the 300 mg/L and 400 mg/L 4-(diethylamino)salicylaldehyde treatment groups at 7 d after the last dose were 50.37% and 58.13%, respectively, and there was no significant difference with the control agent treatment group. 14 d after the last dose, the control effect of the 400 mg/L 4-(diethylamino)salicylaldehyde treatment group was 50.81%, which was significantly higher than that of the control group; while the control effect (44.71%) of the 300 mg/L 4-(diethylamino)salicylaldehyde treatment group was equivalent to that of the control agent treatment group.

Although the above example has described the present disclosure in detail, they are only a part of, not all of, the examples of the present disclosure. Other examples may also be obtained by persons based on the examples without creative efforts, and all of these examples shall fall within the protection scope of the present disclosure.

1. A method for controlling a phytopathogen, comprising applying a 4-(diethylamino)salicylaldehyde to a phytopathogen infected plant.

2. The method according to claim 1, wherein the phytopathogen comprises a phytopathogenic fungus and/or a phytopathogenic bacterium.

3. The method according to claim 1, wherein the phytopathogen is one or more selected from the group consisting of Rhizoctonia solani, Colletotrichum orbiculare, Cladosporium fulvum, Alternaria altemata, Fusarium oxysporum, Xanthomonas oryzae, Pseudomonas syringae pv. lachrymans, Erwinia amylovory, and Acidovorax citrulli.

4. (canceled)

5. The method according to claim 1, wherein 4-(diethylamino)salicylaldehyde in the 4-(diethylamino)salicylaldehyde solution has a concentration of 50 mg/L to 500 mg/L.

6. The method according to claim 1, wherein a preparation process of the 4-(diethylamino)salicylaldehyde solution comprises dissolving the 4-(diethylamino)salicylaldehyde in dimethyl sulfoxide (DMSO) and then diluting with water.

7. The method according to claim 1, wherein the plant is a pear tree; and 3 L of the 4-(diethylamino)salicylaldehyde solution is sprayed on each pear tree during the applying.

8. The method according to claim 1, wherein the applying is conducted 1 to 5 times.

9. The method according to claim 1, wherein the applying is conducted at 1 d/time to 7 d/time.

10. (canceled)

11. The method according to claim 2, wherein the phytopathogen is one or more selected from the group consisting of Rhizoctonia solani, Colletotrichum orbiculare, Cladosporium fulvum, Alternaria alternata, Fusarium oxysporum, Xanthomonas oryzae, Pseudomonas syringae pv. lachrymans, Erwinia amylovory, and Acidovorax citrulli.

12. The method according to claim 7, wherein the applying is conducted at 1 d/time to 7 d/time.
